(19) United States
(12) Patent Application Publication
(10) Pub. No.: US 2017/0042101 A1
(43) Pub. Date: Feb. 16, 2017

(54) AUTOMATIC HOUSEPLANT WATERING DEVICE

(71) Applicant: Fariborz Soltani, Karaj (IR)

(72) Inventor: Fariborz Soltani, Karaj (IR)

(21) Appl. No.: 14/824,629

(22) Filed: Aug. 12, 2015

(51) Int. Cl. A01G 27/00

(52) U.S. Cl. CPC A01G 27/003; A01G 27/008; A01G 27/005

(57) ABSTRACT

An automatic houseplant watering device allowing the rate of water flow or nutrient solution flow, the duration of irrigation, the time of irrigation and the number of irrigations per day to be adjusted by the user. A programmable timer controls a solenoid valve which connects a reservoir to a water distributor. The gravity outflow of water or nutrient solution is transferred from the water distributor to the planters by small size hoses. The rate of water flow or nutrient solution flow to the planters can be adjusted using small valves attached to the end of hoses. A float control valve is used on the upper part of the reservoir to supply water to the reservoir.

### BACKGROUND OF THE INVENTION

The present invention relates generally to devices for watering houseplants and more specifically to automatic and user-friendly devices for watering houseplants which allow the user to easily adjust the rate of water flow, the duration of irrigation, the time of irrigation and the number of irrigations per day.

Regular irrigation is one of the major problems of the owners of houseplants. The problem becomes more serious when the owners stay out of their houses for a relatively long time. The present invention is a device which is able to automatically water the houseplants in human's absence for an unlimited period of time. This device can also be used to feed nutrient solution to the houseplants.

An enormous number of patents which disclose devices or systems for watering houseplants have been presented so far. Many of these patents describe watering devices or systems which should be operated completely manually and can't be used without user's presence. U.S. Pat. No. 4,030,664 to Cosmo N. Tisbo et al, U.S. Pat. No. 4,269,329 to Terry M. Keller, U.S. Pat. No. 4,335,540 to Ron P. Allen, U.S. Pat. No. 4,621,770 to Michael D. Sayen, U.S. Pat. No. 6,644,564 to Jerzy Perkitny, U.S. Pat. No. 6,669,113 to John Halle and U.S. Pat. No. 7,832,146 to Jeff Gordon all are examples of patents which disclose useful houseplant watering devices or systems which should be used manually and will not work in user's absence. Although having useful aspects, obviously such watering devices or systems can't resolve the problem of regular watering when the owners of houseplants are away from their houses.

A considerable number of patents which describe devices or systems for watering houseplants have been devoted to disclosing automatic houseplant watering devices or systems which are capable of watering houseplants in user's absence. Most of these patents describe devices or systems which comprise a water reservoir but suggest no methods for automatically refilling the reservoir. In other words, in most of these patents the reservoir should be refilled manually by the user. As a result the plant owners who may want to use the devices or systems which have been disclosed in these patents can't leave their plants unattended for a very long time for they should manually refill the reservoir of the watering device or system from time to time. U.S. Pat. No. 4,001,967 to June H. Swift, U.S. Pat. No. 4,042,150 to Hans Walter Roos, U.S. Pat. No. 4,096,663 to Stanley Milton Silver, U.S. Pat. No. 4,236,352 to William B. Heaney, U.S. Pat. No. 4,321,937 to Brander M. Littlehale, U.S. Pat. No. 4,329,815 to Allen D. Secrest, U.S. Pat. No. 4,447,983 to Junji Shinanda, U.S. Pat. No. 4,578,897 to Robert A. Pazar et al, U.S. Pat. No. 4,653,529 to Geoffry W. Freeman, U.S. Pat. No. 4,685,827 to Uwe Sibbel, U.S. Pat. No. 4,805,342 to Wayne C. Jenkins, U.S. Pat. No. 4,829,709 to Rocco Centafanti, U.S. Pat. No. 4,848,029 to Joon Ho Han, U.S. Pat. No. 4,937,972 to Joseph, P. Freitus, U.S. Pat. No. 5,097,626 to Yakov Mordoch, U.S. Pat. No. 5,113,888 to Robert Beggs, U.S. Pat. No. 5,351,437 to Fred W. Lishman, U.S. Pat. No. 5,425,198 to Gerald R. Coy, U.S. Pat. No. 5,502,924 to John C. Lee, U.S. Pat. No. 5,511,341 to Jessica Payne, U.S. Pat. No. 5,749,170 to Mikio Furuta, U.S. Pat. No. 5,826,374 to Brian A. Baca, U.S. Pat. No. 5,918,415 to Randal D. Locke et al, U.S. Pat. No. 5,921,025 to Gregory J. Smith, U.S. Pat. No. 5,956,899 to James J. Diorio, U.S. Pat. No. 6,128,856 to Linh V. Doan, U.S. Pat. No. 6,219,963 to Gary Wang, U.S. Pat. No. 6,401,389 to Randy A. Mount et al, U.S. Pat. No. 6,418,664 to Harkeem Shaw, U.S. Pat. No. 6,715,233 to Christopher Lyon, U.S. Pat. No. 7,082,715 to Koen De Winter, U.S. Pat. No. 7,222,454 to Wan-Cheng Chen, U.S. Pat. No. 7,607,257 to Leonard Goldberg et al, and U.S. Pat. No. 8,408,229 to Leonard Goldberg et al, all disclose useful automatic houseplant watering devices or systems which include a water reservoir or container but no automatic methods have been suggested in these patents to refill the water reservoir or container. Consequently the plant owners who may want to use watering devices or systems which have been described in such patents can leave the plants unattended only till the water in the water reservoir or container is not used up. Hence the plant owners can't stay away from their plants for a very long time such as one or two months.

Some of the automatic houseplant watering devices or systems described in the patents, have no electrical components and are purely mechanical or pneumatic or work based on hydromechanics. For example U.S. Pat. No. 4,241,538 to Helmut Lahr U.S. Pat. No. 4,848,029 to Joon Ho Han, U.S. Pat. No. 5,848,494 to Jacob Spelt and U.S. Pat. No. 6,161,329 to Jacob Spelt, are patents which describe purely mechanical automatic houseplant watering devices. The automatic houseplant watering devices disclosed in these patents work based on the weight difference of the planter before and after irrigation. That is when the soil in the planter is dry and hence the planter is lighter, a mechanical system allows water to be transferred from the water supply to the planter. When the planter receives enough water and its weight increases to a predetermined value, the mechanical system prevents water from flowing from the water supply to the planter. Although the automatic houseplant watering devices described in these patents reflect the innovative characteristic of their inventors, the purely mechanical nature of such devices makes it difficult for the users to suitably adjust the rate of the water flow and the duration of irrigation. Plant owners who may want to use such devices should do a lot of trial and errors in order to suitably adjust the rate of the water flow and the duration of irrigation for each planter.

Many of the automatic houseplant watering devices or systems which do not include any electrical components work merely based on capillary action. U.S. Pat. No. 4,216,623 to Stanley Milton Silver, U.S. Pat. No. 4,236,352 to William B. Heaney, U.S. Pat. No. 4,685,827 to Uwe Sibbel, U.S. Pat. No. 4,829,709 to Rocco Centafanti, U.S. Pat. No. 5,425,198 to Gerald R. Coy, U.S. Pat. No. 5,921,025 to Gregory J. Smith, U.S. Pat. No. 6,128,856 to Linh V. Doan, U.S. Pat. No. 6,219,963 to Gary Wang, U.S. Pat. No. 6,401,389 to Randy A. Mount et al, U.S. Pat. No. 6,418,664 to Harkeem Shaw and U.S. Pat. No. 7,082,715 to Koen De Winter, are examples of patents which disclose automatic houseplant watering devices or systems which work merely based on capillary action. The disadvantage of the devices described in such patents is that no controller has been suggested to allow the user to properly adjust the rate of water flow and the duration of irrigation.

Some of the automatic houseplant watering devices or systems which comprise no electrical components, work based on capillary action and vacuum relief. U.S. Pat. No. 4,001,679 to June H. Swift, U.S. Pat. No. 4,329,815 to Allan D. Secrest, U.S. Pat. No. 4,653,529 to Geoffry W. Freeman, U.S. Pat. No. 4,578,897 to Robert A. Pazar and U.S. Pat. No. 5,956,899 to James J. Diorio, are instances of patents which describe automatic houseplant watering devices or systems which operate based on capillary action and vacuum relief and have no electrical components. Such devices usually comprise a water supply responsive to vacuum relief. A vent which is inserted into the soil of the planter communicates with the water supply. When the soil in the planter is wet enough, the vent is unable to suck any air from the soil. As a result negative air pressure inside the water supply prevents water from flowing to the planter. After that the soil of the planter loses moisture, it allows the vent to suck some air into the water supply. Consequently the vacuum inside the water supply is relieved and some water flows from the water supply to the planter. Finally water is transferred to the roots of the plant through capillary action. Considering the fact that various plants require various levels of moisture, it would be difficult for the user of such watering devices to suitably adjust the rate of water flow and the duration of irrigation.

The automatic houseplant watering devices or systems which include electrical components are more user-friendly in comparison to those which do not comprise electrical components. The plant owners who use such devices and systems can easily adjust the rate of water flow and duration of irrigation through electrical components such as timers and sensors. However, automatic watering devices which comprise electrical components such as pumps, timers, microprocessors, sensors etc, are more expensive than previously described devices and produce some costs due to the consumption of electric energy. Besides the automatic watering devices which include pumps make a little noise which may be unpleasant for the users. U.S. Pat. No. 4,447,983 to Junji Shinanda, U.S. Pat. No. 4,834,265 to Stuart D. Snyder, U.S. Pat. No. 4,937,972 to Joseph P. Freitus, U.S. Pat. No. 5,351,437 to Fred W. Lishman, U.S. Pat. No. 5,634,342 to John P. Peeters, U.S. Pat. No. 5,749,170 to Mikio Furuta, U.S. Pat. No. 5,826,374 to Brian A. Baca, U.S. Pat. No. 7,222,454 to Wan-Cheng Chen, U.S. Pat. No. 7,607,257 to Leonard Goldber et al and U.S. Pat. No. 8,408,229 to Leonard Goldberg et al are examples of patents which disclose automatic houseplant watering devices or systems with electrical components. The plant owners, who may want to use watering devices or systems described in these patents, can easily and properly adjust the rate of water flow and the duration of irrigation through electrical components of these devices and systems.

Considering all facts mentioned about the existing patents on houseplant watering devices or systems, there is a need for an automatic houseplant watering device which is able to water houseplants in user's absence for an unlimited period of time. The device should also be user-friendly so that the user can easily adjust the rate of water flow, the duration of irrigation, the time of irrigation and the number of irrigations per day. The device should be economical too. That is, the price of the device and its energy consumption rate should be reasonable.

### OBJECTS OF THE INVENTION

The primary object of this invention is to provide an automatic houseplant watering device in order to automatically water houseplants in user's absence for an unlimited period of time.

Another object of the present invention is to provide an automatic houseplant watering device which enables the user to easily adjust the rate of water or nutrient solution flow from the device to the planter.

A further object of this invention is to provide an automatic houseplant watering device which allows the user to easily adjust the duration of irrigation.

Another object of this invention is to provide an automatic houseplant watering device which enables the user to easily adjust the time of irrigation.

A further object of this invention is to provide an automatic houseplant watering device which allows the user to easily adjust the number of irrigations per day.

Another object of the present invention is to provide an automatic houseplant watering device which is economical and has a reasonable rate of energy consumption.

A further object of this invention is to provide an automatic houseplant watering device which does not occupy the useful space of the house.

### SUMMARY OF THE INVENTION

Disclosed is an automatic houseplant watering device which is capable of automatically watering houseplants in user's absence for an unlimited period of time. The present invention comprises a water or nutrient solution reservoir which has a side wall, a bottom and a lid. There is a circular opening on the upper part of the reservoir to attach a float control valve to the reservoir. The float control valve is applied to supply water to the reservoir and to control the height of water inside the reservoir. There is another circular opening on the lower part of the reservoir to attach a solenoid valve to the reservoir. The float control valve communicates with a water supply—which is usually a water valve—through a hose. Hence the water reservoir is automatically refilled by the float control valve in user's absence. All hoses attached to the device are preferred to be small in size (preferably 6 mm in diameter) and transparent so that they do not affect the aspect of the house. However other types of hoses can be used too. The solenoid valve is a normally closed valve, and may be operated by an AC or DC electric power source. The solenoid valve is controlled by a programmable timer which may be operated by an AC or DC electric power source. The timer can be easily adjusted by the user to open the solenoid valve at desired times and for desired periods of time. The outlet of the solenoid valve is attached to the inlet of a water distributor which includes a plurality of outlets. Each outlet of the distributor is attached to a small size transparent hose and each hose goes to a planter. A small valve is attached to the end of each hose to enable the user to separately adjust the rate of water or nutrient solution flow to each planter.

Since the water or nutrient solution inside the reservoir flows to planters due to the gravitational force, the reservoir should be located in a place higher than planters. Although it is possible to use a small pump instead of the solenoid valve, the solenoid valve is preferred because the rate of energy consumption of a solenoid valve is much less than that of a small pump. Besides a small pump makes a little noise when operating which may be unpleasant in a house but a solenoid valve makes absolutely no noise. Also note that the area of some places where planters are located at—such as the balcony of an apartment—is quite limited. Hence locating the automatic houseplant watering device on a shelf at a height of 2 m to 2.2 m above the floor of small places such as a balcony would save some of the useful space of that place. If a water valve is available close enough to the planters and the user does not want to use the device to feed the plants with nutrient solution, then there would be no need for the reservoir and the float control valve. In this case the solenoid valve together with the water distributor can be attached to the water valve.

### BRIEF DESCRIPTION OF THE DRAWINGS

FIG. 1 illustrates a perspective view of the present invention.

FIG. 2 illustrates another perspective view of the present invention.

FIG. 3 illustrates a perspective view of the present invention for the case where a water valve is available close enough to the planters and there is no need for the reservoir and the float control valve.

FIG. 4 illustrates a perspective exploded view of the reservoir, its adapter, a sealing O-ring and a nut for fastening the adapter to the reservoir.

FIG. 5 illustrates a perspective exploded view of the float control valve, a gasket, a hose barb and the inlet hose.

FIG. 6 illustrates a perspective exploded view of the solenoid valve and two hex nipples which connect the solenoid valve to the reservoir and the water distributor.

FIG. 7 illustrates a perspective view of the timer.

FIG. 8 illustrates a perspective exploded view of the water distributor.

FIG. 9 illustrates a perspective exploded view of the small valve attached to the end of the irrigation hose.

FIG. 10 illustrates another perspective exploded view of the small valve attached to the end of the irrigation hose.

### DETAILED DESCRIPTION OF THE INVENTION

The present invention was developed to automatically water houseplants in user's absence for an unlimited period of time. In addition, this invention was developed to enable the user to easily adjust the rate of water flow, the duration of irrigation, the time of irrigation and the number of irrigations per day. The present invention is economical and has a lower rate of energy consumption in comparison to other electromechanical houseplant watering devices or systems.

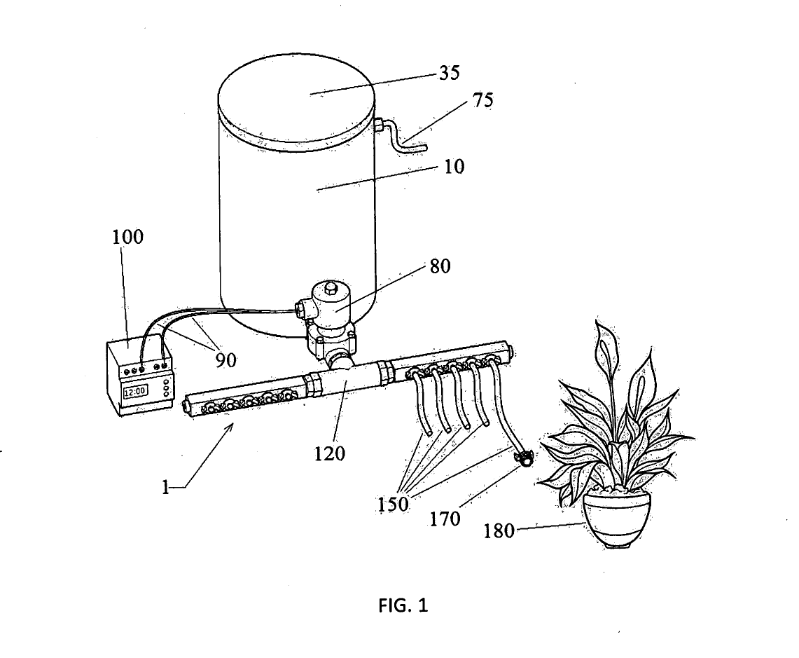

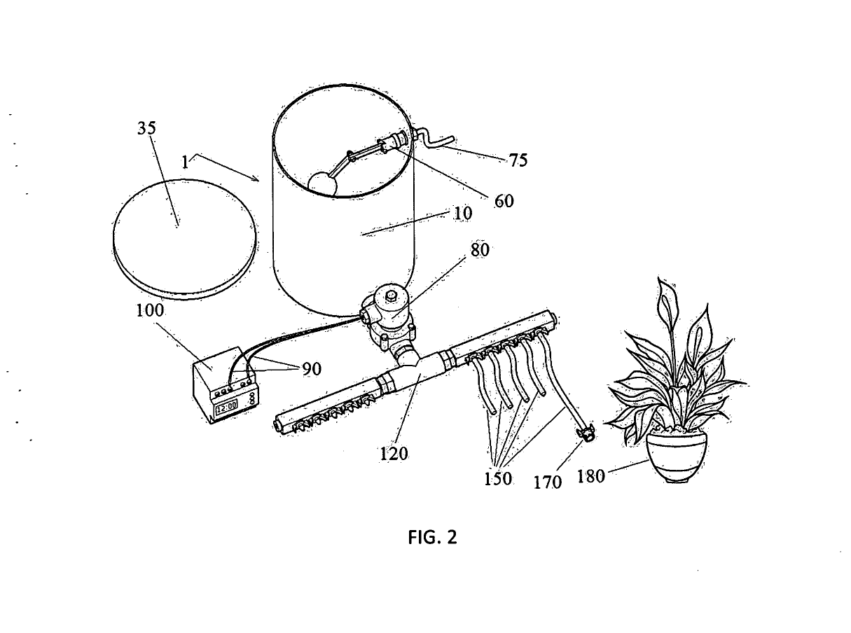

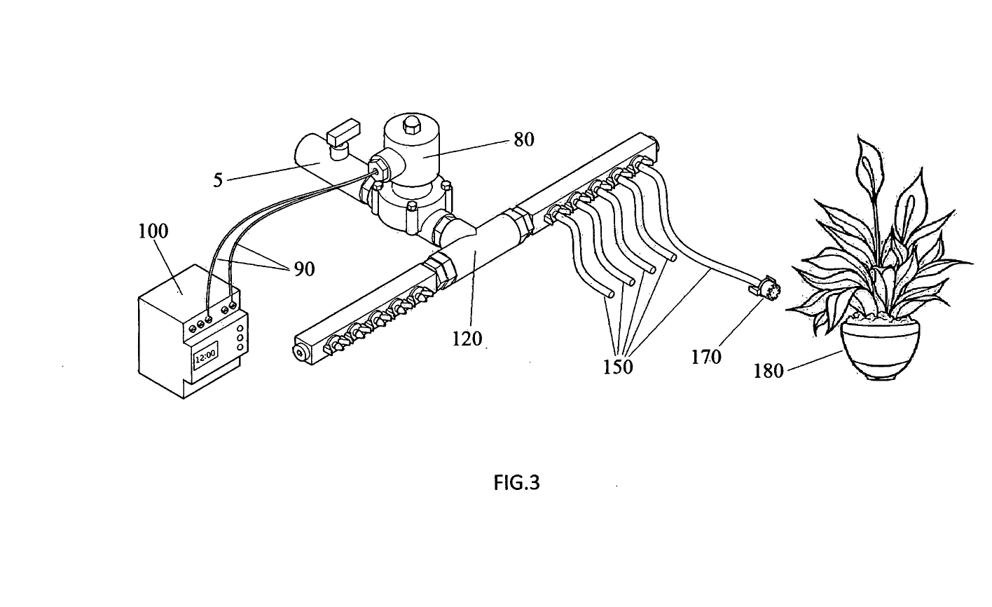

As illustrated in FIG. 1 and FIG. 2, the invention 1 comprises a reservoir 10, a float control valve 60, an inlet hose 75, a solenoid valve 80, a programmable timer 100, wires 90 which connect the solenoid valve 80 to the timer 100, a water distributor 120, a plurality of irrigation hoses 150 and small valves 170 attached to the end of irrigation hoses 150 to separately control the flow of water or nutrient solution to each planter 180. FIG. 3 shows that in the case where a water valve 5 is available close enough to the planters 180 and the user does not want to use the device 1 in order to feed the planters 180 with nutrient solution, then there is no need for the reservoir 10 and float control valve 60. In this case the solenoid valve 80 can be attached to the water valve 5.

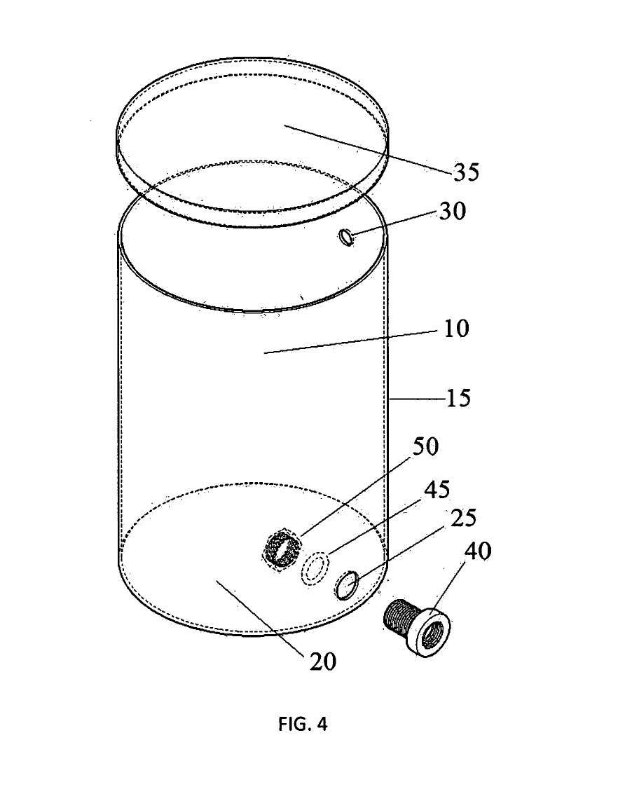

As illustrated in FIG. 4 the reservoir 10, includes a bottom 20, a sidewall 15 and a lid 35. The reservoir 10 has been chosen to be cylindrical but it may be in any other suitable shape such as cubic too. The reservoir 10 is preferred to be made of transparent plastic in order to be light and to reveal the height of water inside it but it can be made of other suitable materials too. There is a circular opening 30 on the upper part of the sidewall 15 which is used to attach the float control valve 60 to the reservoir 10. There is another circular opening 25 on the lower part of the sidewall 15 to attach the solenoid valve 80 to the reservoir 10. An adapter 40 whose size matches that of the lower circular opening 25, is inserted into the lower circular opening 25. An O-ring 45 and a nut 50 are applied to seal the lower circular opening 25, and fix the adapter 40 to the sidewall 15. All fittings applied to the device 1 are preferred to be made of either PVC or Polyethylene to make the device 1 as light as possible. However metallic fittings can be used too.

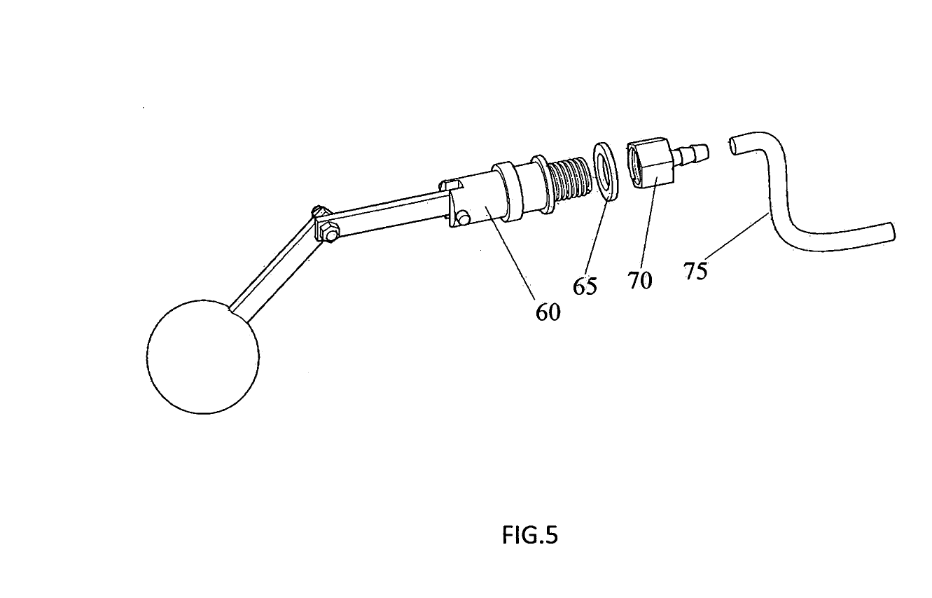

A float control valve 60 is attached to the reservoir 10 through the upper circular opening 30. Hence the reservoir 10 is automatically refilled in user's absence by the float control valve 60. FIG. 5 shows that a gasket 65 and a hose barb 70 are used to fix the float control valve 60 to the sidewall 15 of the reservoir 10. The hose barb 70 is also used to attach the inlet hose 75 to the float control valve 60. The other end of the inlet hose 75 should be attached to a water valve. The inlet hose 75 and all irrigation hoses 150 are preferred to be transparent and small in size (6 mm) so that they do not affect the aspect of the house, but other types of hoses can be used too.

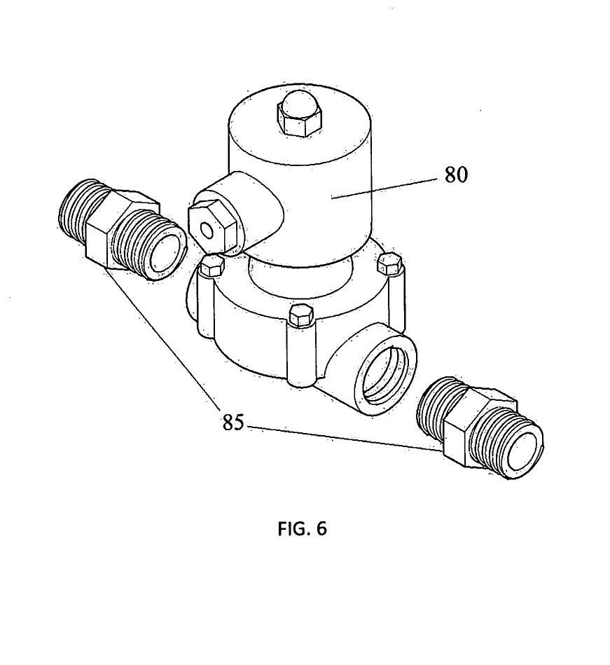

A hex nipple 85 is used to attach the solenoid valve 80 to the reservoir 10 through the lower opening 25 and the adapter 40. FIG. 6 illustrates how two hex nipples 85 are attached to the inlet and outlet of the solenoid valve 80. The solenoid valve 80 is a normally closed valve which is capable of operating at zero pressure. The solenoid valve 80 may be operated by an AC or DC electric power source. The size of the solenoid valve 80 depends on the number of planters 180 to be irrigated, the desired duration of irrigation and the required rate of water or nutrient solution flow. According to my experience a solenoid valve of ½″ with an orifice of 15mm is capable of simultaneously watering up to ten medium size planters in about 35 seconds.

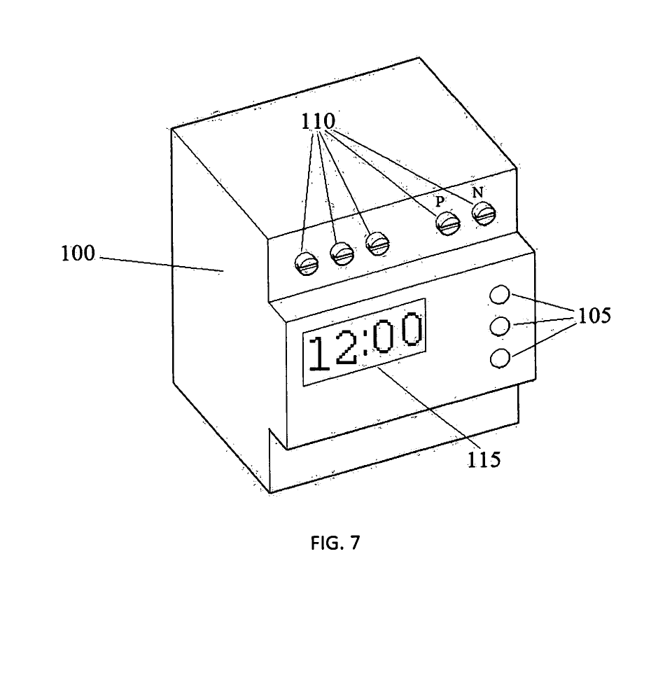

FIG. 7 illustrates the programmable timer 100 which controls the solenoid valve 80. The timer 100 is applied to adjust the time of irrigation, the duration of irrigation and the number of irrigations per day. The user can easily adjust the mentioned irrigation parameters by means of programming buttons 105 provided on the timer 100. The timer 100 also includes a time display 155 and some terminals 110 to attach the wires 90 which connect the timer 100 to the solenoid valve 80 and to the electric power source. The programmable timer 100 may be operated by an AC or DC electric power source.

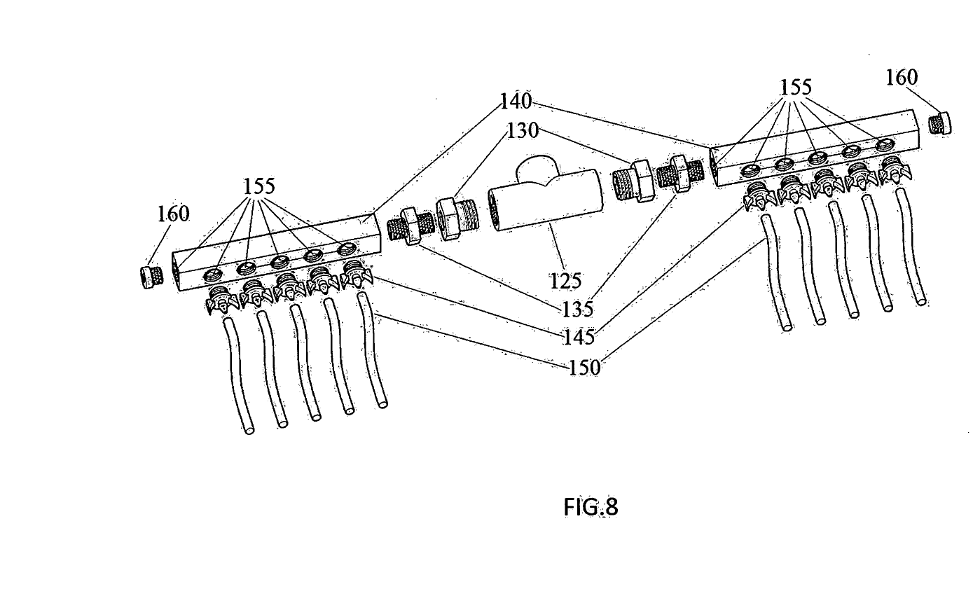

The water distributor 120 has been shown in the perspective exploded view in FIG. 8. As illustrated in FIG. 8, the water distributor 120, includes a ½″ tee 125, two ½″ to ¼″ adapters 130, two ¼″ hex nipples 135, two distribution bars 140 with a plurality of ¼″ openings 155, some hex plugs 160 to shut the unwanted openings, a plurality of hose barbs 145 and a plurality of 6 mm irrigation hoses 150. Please note that the sizes given here for the components of the water distributor may change according to the number of planters to be watered.

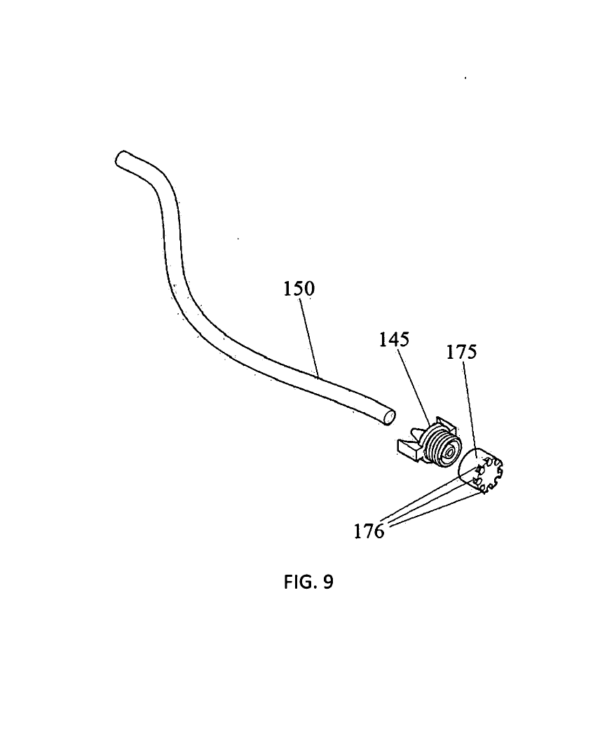

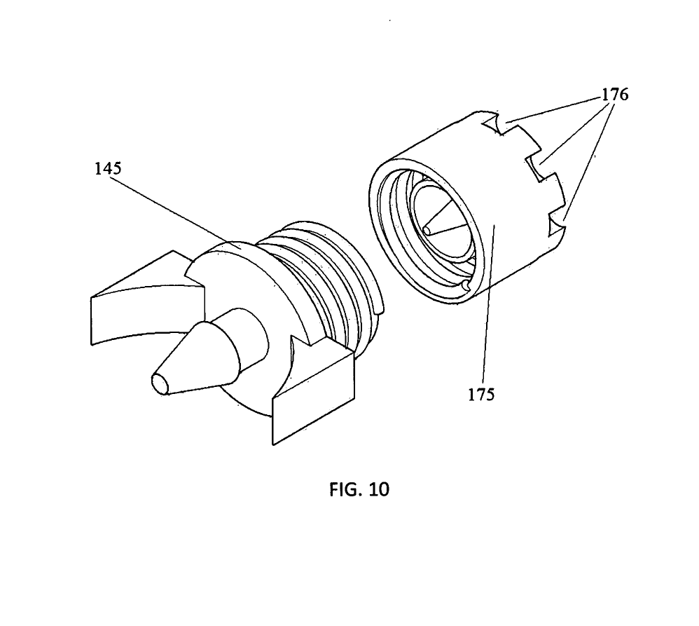

An irrigation hose 150 together with a small valve 170 have been illustrated in FIG. 9. The small valve 170 is made of a hose barb 145 and a threaded cap 175 with a plurality of small openings 176 on it. Water flows through the small openings 176 of the threaded cap 175 to the planter 180. The user can adjust the rate of the water or nutrient solution flow by rotating the threaded cap 175. FIG. 10 illustrates another perspective exploded view of the small valve 170.

### OPERATION

Initially the device 1 is located in a place higher than the planters 180. In order to avoid occupying the useful space of the house it is recommended to locate the device 1 at a height of 2 m to 2.2 m from the floor. The inlet hose 75 is attached to a water valve which may be far away from the device 1. Note that, since the inlet hose 75 is transparent and small in size (preferably 6 mm in diameter) even if it passes through the indoor space, it will not affect the aspect of the house. Then the reservoir 10 is filled with water by the float control valve 60. Next the timer 100 is programmed by the user to open the solenoid valve 80 at desired times of the day for desired durations. The user may add some nutrient to the water inside the reservoir 10 too. At the desired time of irrigation, the timer 100 connects the solenoid valve 80 to an electric power source which may be an AC or DC power source. In this case the solenoid valve 80 opens and the gravity force makes water or nutrient solution, flow from the reservoir 10 to the water distributor 120. The water or nutrient solution flow from the solenoid valve 80 is divided to smaller flows inside the water distributor 120 and each smaller flow of water or nutrient solution reaches a small valve 170 at the end of the irrigation hose 150. The rate of water or nutrient solution flow to each planter 180 can be separately adjusted by the user through the small valves 170 attached to the end of the irrigation hoses 150. The water or nutrient solution which flows out of the reservoir 10 during each irrigation, is automatically replaced by the inlet water through the float control valve 60.

What is claimed is:

1) An automatic houseplant watering device comprising:
a) a reservoir with a bottom, a sidewall and a lid.
b) automatic refilling means to automatically refill the said reservoir.
c) a solenoid valve attached to the said reservoir.
d) a programmable timer connected to the said solenoid valve.
e) a water distributor attached to the outlet of the said solenoid valve.
f) irrigation hoses for transferring water from the said water distributor to the planters.
g) flow control means attached to the said hoses to adjust the rate of water or nutrient solution flow to the planters.

2) the automatic house watering device as claimed in claim 1 wherein the said reservoir and the said automatic refilling means are not installed.

3) the automatic houseplant watering device as claimed in claim 1 wherein the said refilling means are attached to the said reservoir with or without fixing and sealing components and materials.

4) the automatic houseplant watering device as claimed in claim 1 wherein the said solenoid valve is attached to the said reservoir with or without fixing and sealing components and materials.

5) the automatic houseplant watering device as claimed in claim 1 wherein the said solenoid valve is connected to the said programmable timer with or without wires.

6) the automatic houseplant watering device as claimed in claim 1 wherein the outlet of the said solenoid valve is attached to the inlet of the said water distributor with or without fixing and sealing components and materials.

7) the automatic houseplant watering device as claimed in claim 1 wherein the said irrigation hoses are attached to the water distributor with or without fixing and sealing components and materials.

8) the automatic houseplant watering device as claimed in claim 1 wherein the said flow control means are attached to the said irrigation hoses with or without fixing and sealing components and materials.

9) the automatic houseplant watering device as claimed in claim 2 wherein the said solenoid valve is attached to a water valve with or without fixing and sealing components and materials.

10) the automatic houseplant watering device as claimed in claim 2 wherein the said solenoid valve is connected to the said programmable timer with or without wires.

11) the automatic houseplant watering device as claimed in claim 2 wherein the outlet of the said solenoid valve is attached to the inlet of the said water distributor with or without fixing and sealing components and materials.

12) the automatic houseplant watering device as claimed in claim 2 wherein the said irrigation hoses are attached to the outlets of the said water distributor with or without fixing and sealing components and materials.

13) the automatic houseplant watering device as claimed in claim 2 wherein the said flow control means are attached to the said irrigation hoses with or without fixing and sealing components and materials.
